(19) United States
(12) Patent Application Publication
(10) Pub. No.: US 2008/0057157 A1
(43) Pub. Date: Mar. 6, 2008

(54) Puffed Cracker-Like Food Products And Method Of Making

(76) Inventors: Helbert Almeida, Battle Creek, MI (US); Brian Armstrong, Portage, MI (US); Brian J. Anderson, Augusta, MI (US)

Correspondence Address: Kristine H. Johnson;Dickinson Wright PLLC, Ste. 2000, 38525 Woodward Ave., Bloomfield Hills, MI, 48304-2970, US

(21) Appl. No.: 11/848,628

(22) Filed: Aug. 31, 2007

Related U.S. Application Data
(60) Provisional application No. 60/841,586, filed on Aug. 31, 2006.

(51) Int. Cl. A21D 13/08; A21D 8/02; A23L 1/30

(52) U.S. Cl. 426/20; 426/19; 426/446; 426/549; 426/74; 426/94

(57) ABSTRACT

The present invention provides puffed, crisp, cracker-like food products comprising at least two layers of baked dough defining at least one cavity, wherein said cavity is substantially defined by secured dough perimeter. Also provided are methods to make the puffed, crisp, cracker-like food products described herein. In particular, there are provided methods to make a puffed, crisp food product, comprising: providing leavening means between at least two sheets of dough; securing said dough sheets so as to define at a perimeter; causing at least one cavity to form within said perimeter, wherein said cavity is defined by said perimeter. Purposeful development of large cavities within a sturdy, yet crisp cracker results in a surprisingly high rate of uncrushed crackers, and a surprisingly high rate of reproducible product attributes. Enhancements of the present invention are also provided.

### BACKGROUND OF THE INVENTION

This invention relates to puffed cracker-like food products and methods of making puffed cracker-like food products. More specifically, the present invention relates to especially crisp and unusually functional food products having at least one fillable cavity, as well as efficient, cost-effective methods for making the food products.

Most crackers, whether fermented or non-fermented, have very small, bubble-like cavities (blisters) that are a result of either steam generation during baking, microoganisms that generate gas as a by-product, or the addition of a leavening agent as an ingredient in the dough.

While occasional small surface bubbles are a desirable feature in some cracker types, crackers with large or profuse air pockets are generally considered failed product in the cracker industry. Such crackers typically break easily, and, as a result, become crushed during transport to market. Moreover, purposeful development of such large cavities within a sturdy, yet crisp cracker, as is described in the present invention, entails a novel approach in order to result in a surprisingly high rate of uncrushed crackers, as well as a surprisingly high rate of reproducible physical attributes.

These new physical attributes offer a wide variety of functional features that were impossible prior to the present invention. For instance, puffed cracker-like products of the present invention may be filled a variety of fillings, such as cheeses, chocolates, creams, nut pastes, gelatins, and/or fruit fillings. A particularly unusual function of the present invention is the ability to trap large particulates in an air pocket. Nuts or nut pieces, candy pieces, nougat pieces, meat pieces, and the like can be enveloped such that they tumble freely in the pocket. With no obvious entrance point for such inclusions, the food product is particularly entrancing to consumers. Both filled and unfilled cracker-like products of the present invention have distinctive mouth-feel, and provide a sensory experience unlike previous crackers.

### SUMMARY OF THE INVENTION

The present invention provides puffed, crisp, cracker-like food products comprising at least two layers of baked dough defining at least one cavity, wherein said cavity is substantially defined by secured dough perimeter. Preferred food products are those wherein at least one cavity is 20 to 70% of the total volume of the food product. More preferred are those wherein the cavity is 30 to 50% of the total volume of the food product. Most preferred are those wherein the cavity is approximately 40 to 45% of the total volume of the food product. Also preferred are those embodiments wherein the food product comprises a bottom and a top layer, with the top layer having a greater mass than the bottom layer. Most preferred are those embodiments where the top is readily-recognized as a dome shape.

Preferred are those food products as described which comprises one to three cavities, more preferably one cavity.

Preferred food products are those made from flavored cracker dough. More preferred are those food products made from a dough flavor selected from the group consisting of: buttery flavor; multi-grain flavor; cheddar flavor; chocolate flavor; wheat flavor; cinnamon flavor; onion flavor; fish flavor; pretzel flavor; garlic flavor; parmesan flavor; graham flavor; sesame flavor; corn flavor; legume flavor; beef flavor; chicken flavor; lamb flavor; shrimp flavor; nacho seasoning flavor; potato flavor; green chile flavor; ranch salad dressing flavor; tomato flavor; apple flavor; mint flavor; rosemary flavor; mixed fruit flavor; mixed vegetable flavor; mixed meat flavor; mixed spice flavor; and mixed herb flavor.

Also preferred are those food products which comprises a seasoning on at least one surface. More preferred are those which comprise a seasoning on either the outside or the inside of the puffed surface; however, also more preferred are those wherein all surfaces are seasoned. In one embodiment, oil is applied to at least one surface of the baked product, and seasoning is applied. In another embodiment, a starch slurry is applied to at least one surface of the baked product, seasoning is applied, and the cracker dried.

Also preferred are those food products which further comprise a filling. Such filled food products preferably are formulated from a filling base selected from the group consisting of: oil base filling; gum base filling; fruit base filling; and gelatin base filling. More preferred food products comprise a flavored filling, with the most preferred embodiments being those wherein the filling is a flavor selected from the group consisting of: vanilla flavor; strawberry flavor; raspberry flavor; caramel flavor; squash flavor; butter flavor; cheddar flavor; blue cheese flavor; nacho cheese flavor; chocolate flavor; cinnamon flavor; onion flavor; fish flavor; pretzel flavor; garlic flavor; parmesan flavor; malt flavor; sesame flavor; legume flavor; beef flavor; chicken flavor; lamb flavor; shrimp flavor; potato flavor; green chile flavor; tomato flavor; apple flavor; peach flavor; banana flavor; cranberry flavor; pomegranate flavor; green tea flavor; grape flavor; raisin flavor; liqueur flavor; liquor flavor; wine flavor; beer flavor; mint flavor; rosemary flavor; basil flavor; cilantro flavor; chive flavor; mixed fruit flavor; mixed vegetable flavor; mixed meat flavor; mixed spice flavor; and mixed herb flavor.

Also provided are puffed, crisp, cracker-like food products comprising at least two similar doughs, or two different doughs as the layers. Food products provided preferably include doughs that have not been sweetened, but also include those doughs that have been sweetened. Also preferred are food products which comprise at least one whole grain ingredient, and/or at least one nutritive enhancer. Such food products preferably comprise a nutritive enhancer selected from the group consisting of: soluble fiber; insoluble fiber; fructo-oligosaccharides; inulins; psyllium husk fiber; citrus fiber; oat fiber; microground fiber; vegetable gums; dextrins; resistant starches; grain brans; oat brans; wheat brans; corn brans; cactus extracts; beta carotene; quinoa; whey protein extracts; omega fatty acids; spirulinas; brown seaweeds; probiotics; prebiotics; ginko bilboa; flax seed; flax seed oil; saw palmetto; grape seed extract; milk thistle; bilberry; green tea; Echinacea; cohosh; cayenne; saponins; antioxidants; ginsing; wild yam extract; yohimbe; noni; algae; fruit vinegar; fruit concentrate; mangosteen; acai; goji; pomegranate; wheat grass; chlorella; sterols; wheat grass; alfalfa; barley grass; phytonutrients; beet fiber; oat fiber; apple pectin; black current fiber; flavones; isoflavones; soy; evening primrose oil; essential fatty acids; eicosapentanoid acid; docosahaenoic acid; bee pollen; royal jelly; creatine; caffeine; zinc; vitamins; minerals; aloe; Hoodia; conjugated linoleic acid; Caralluma fibriata; and olive oil.

Also provided are methods to make the puffed, crisp, cracker-like food products described herein. In particular, there are provided methods to make a puffed, crisp food product, comprising: providing leavening means between at least two sheets of dough; securing said dough sheets so as to define at a perimeter; causing at least one cavity to form within said perimeter. Preferred are those methods wherein the leavening means is selected from the group consisting of: causing a fermenting microorganism to ferment; reacting a base with an acid; and heating a heat-activated leavening agent. Most preferred are those methods wherein said leavening means comprises at least one leavening agent selected from the group consisting of: yeasts; probiotic bacteria; ammonium bicarbonate; sodium bicarbonate; calcium bicarbonate; carbonates; sodium salts; calcium salts; ortho-phosphoric acids; pyro-phosphoric acid; complex phosphoric acids; monocalcium phosphate monohydrate; monocalcium phosphate anhydrous; sodium acid pyrophosphate; sodium aluminum phosphate; dicalcium phosphate dehydrate; dicalcium phosphate; sodium aluminum sulfate; glucono-deltalactone; potassium hydrogen tartrate; sodium aluminum phosphate.

Preferred are those methods wherein the leavening means is ammonium bicarbonate and wherein the cavity is caused by subjecting the dough layers and ammonium bicarbonate to heat sufficient to cause said dough layers to separate, said ammonium bicarbonate to dissipate, and said perimeter to remain substantially secured.

Methods wherein said dough sheets are secured by cutting the dough sheets after layering are preferred, as are those which further comprises crimping the cut sheets.

In particular there are provided methods to make a puffed, crisp food product, comprising: providing a first sheet of dough; providing a layer of ammonium bicarbonate to the surface of the first sheet of dough; providing a second sheet of dough to the surface of the ammonium bicarbonate; cutting said doughs and ammonium bicarbonate layer so as to secure a perimeter of dough; and baking so as to activate the ammonium bicarbonate and crisp the dough. Those specific methods wherein the doughs are less than two millimeters in thickness prior to baking are preferred, although those wherein the doughs are from 0.5 to 1.5 mm in thickness are most preferred.

### DEFINITIONS

“Between at least two sheets of dough” as used in the present invention includes ingredients on a surface of at least one dough sheet, and does not exclude the possibility that the same ingredient may be in the dough itself, in addition to on the surface of a dough sheet. “Between” does not imply the mid point of two dough sheets, rather, “between” may mean, for example, on the bottom surface of the top sheet, or the top surface of the bottom sheet, or included with other ingredients in a filling.

“Secured” as used in the present invention means that the doughs are engaged such that they no longer completely resemble two separate dough sheets, and are instead essentially one dough piece. “Securing” can therefore mean any pressing of dough together with enough force as to substantially join the matrices of the dough, including cutting, crimping, pressing, fluting, pushing, mashing, etc.

“Substantially free of baked dough obstructions” as used in the present invention means that very few strands of baked dough transverse from surface to surface within the cavity. Occasional strands of baked dough, especially toward the margins, and especially those placed sparingly by design or dockering, are acceptable, provided that the main feature is one of an open space between the baked layers.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a front elevational view of a puffed, crisp cracker-like food product of the present invention;

FIG. 2 is a side elevational view of a puffed, crisp cracker-like food product;

FIG. 3 is a cross-sectional view of a puffed, crisp cracker-like food product taken along line 3-3 in FIG. 1;

FIG. 4 is a partial sectional view of the continuous combined sheets used to form a puffed, crisp cracker-like food product;

FIG. 5 is a top plan view of an intermediate food product of the present invention, prior to baking and puffing;

FIG. 6 is a cross-sectional view of an intermediate food product taken along line 6-6 in FIG. 5; and

FIG. 7 is a flow chart of an exemplary process used to form a puffed, crisp cracker-like food product.

### DETAILED DESCRIPTION

### Dough

Cracker dough used in the present invention can be any type of edible cracker dough, including, for example, laminated or non-laminated cracker dough, cracker dough with some sweeteners added, cracker dough that is leavened, cracker dough that has been fermented, cracker dough with flavorings and/or cracker dough with inclusions or toppings. Lamination and layering may be accomplished according to any method that results in the appropriate configuration described herein.

Cracker dough useful in the present invention preferably includes those selected from the group consisting of: soda cracker; multi-grain cracker; high fiber cracker; high protein cracker; wheat cracker; butter cracker; cheese-flavored cracker; graham cracker; and flatbread cracker.

Cracker dough useful in the present invention is made according to methods generally known in the art, and includes mixing flour, fat and moisture (ordinarily water) and most often, salt. Optional ingredients, such as sweeteners, flavors, inclusions, colors, nutritional supplements, leavening agents, sulfites, and dough conditioners, such as emulsifiers, reducing agents, oxidizing agents may be added as well.

The present invention includes use of the same dough for each of the layers, but also includes combinations of dough layers in one layered composition, for example two layers each having a different type (color, flavor, inclusions, processing differences, etc.) of cracker dough. Any particular layer itself may be a hybrid of dough types as well, so as to provide any functional or aesthetic result, provided that the purpose of the invention is not thwarted.

The flour component in cracker dough useful in the present invention may be any edible flour, including hard wheat flour, soft wheat flour, corn flour, rye flour, rice flour, barley flour, graham flour, whole wheat flour, high amylose flour, low amylose flour, and the like. Most preferably, the flour component is a blend of flour types, or a blend of flours and fibers. For instance, a combination of corn flour, wheat flour and fiber may be used as the flour component in the present invention. When using fiber in the flour component, those in the art appreciate the physical attributes of soluble and insoluble fibers, and may modify the blend according to the desired outcome.

Wheat flours are preferred, but other flours conventionally used in the preparation of baked goods are also employed in full or partial substitution for the wheat flour. One protein range for wheat flour used in the present invention is between about 7 to 15% by weight of the flour. In general, intermediate gluten levels are better suited to processing of cracker doughs, although those in the art are aware of modifications necessary to achieve the same sheetability with other flours, either in combination with fibers or not.

The fat component in cracker dough useful in the present invention may comprise any edible fat, oil, or shortening, including those that are solid at room temperature and those that are liquid at room temperature. Liquid shortenings or oils are usable and provide an advantage of ease or incorporation. Solid shortening is usable and provides an advantage of desirable mouthfeel upon consumption of the baked good. More commonly used are mixtures of liquid and solid shortenings. These mixtures are fluid or plastic depending, in part, on the level of solid fatty materials. Liquid shortening includes animal shortening, marine fats, vegetable or synthetic oil, such as sucrose polyesters, which are liquid at ordinary room temperature. The fat component of the present invention may comprise natural or hydrogenated oils, including soybean oil, cottonseed oil, canola (rapeseed) oil, peanut oil, safflower oil, sesame oil, sunflower oil, poppyseed oil, coconut oil, palm oil, palm kernel oil, olive oil, butterfat, cocoa butter, tallow, lard, babassue, corn oil, or combinations thereof.

Sweeteners may optionally be added to a cracker dough useful in the present invention, but only at levels that do not interfere with the ability of the cracker dough to form a sheet. According to the invention, any suitable sweetener can be present, including liquid or dry sweeteners. Typical sweeteners include corn syrup, high fructose corn syrup, maltose, malt syrup, malt syrup solids, honey, maple syrup, rice syrup, rice syrup solids, sorghum syrup, refiners syrup, corn syrup solids, dextrose, fructose, crystalline fructose, galactose, glucose, lactose, sucrose, brown or invert sugars, molasses and other compositions that substantially comprise sugars, whether crystalline, syrup or other physical form, and combinations thereof. Preferably, the food items of the present invention comprise sucrose as the form of granulated sugar. Sugar substitutes can also be used according to the invention, including, for example, saccharine, acesulfone K, aspartame, sucralose, d-tagatose and the like. Such sugar substitutes can be used in addition to, or as a substitute for, any sweetener used.

Cracker doughs useful in the present invention optionally further comprise emulsifiers. Generally useful emulsifier components are partially-esterified polyhydric compounds having surface active properties. This class of emulsifiers includes among others, mono- and di-glycerides of fatty acids, such as monopalmitin, monostearin, monoolein, and dipalmitin; partial fatty esters of glycols, such as propylene glycol monostearate and monobehenate; higher fatty acid esters of sugars, such as the partial palmitic and oleic acid esters of sucrose; and phosphoric and sulphuric acid esters, such as dodecylglyceryl ether sulfate and monostearin phosphate. Other examples include the partial esters of hydroxy carboxylic acid such as lactic, citric, and tartaric acids with polyhydric compounds, for example, glycerol lacto palmitate and the polyoxyethylene ethers of fatty esters of polyhydric alcohols, such as polyoxyethylene ether of sorbitan monostearate or distearate. Fatty acids alone or esterified with a hydroxy carboxylic acid, e.g., stearyl-2-lactylate are also useful. In certain variations, all or a portion of the emulsifier component is pre-blended with the shortening or fat component. However, in other variations, a portion of the emulsifiers can be pre-hydrated and added along with the other wet ingredients. In still other variations, the emulsifiers can be plated onto various solid carriers such as flour, starch, sugars, and the like, and admixed in with the various dry ingredients.

Cracker doughs useful in the present invention also optimally comprise salt, for flavor and function. Any food-grade salt is acceptable, although those in the art are aware that certain salts lend themselves to better results than others. For instance, the salt may be chosen from, but is not limited to, sodium chloride, potassium chloride, calcium chloride, naturally-occurring sea or other salts, or combinations thereof.

Optionally, the cracker doughs may comprise any leavening agent, particularly including any microbial or chemical agents that are described herein. A preferred leavening agent useful in the doughs of the present invention is a SAPP, particularly SAPP 28.

Optionally, the cracker doughs and optional fillings useful in the present invention may comprise additional flavorant components, inclusions, and/or nutritive enhancers. Flavorants may be any of those known in the art and may include, cheese, cheese powder, yeasts, spices, paprika, garlic, herbs flavors, fruit flavors, chocolate, etc. Inclusions may be any of those known in the art and may include oats, nutmeats, seeds, candy pieces, fruit pieces, meat pieces, etc.

Nutritive enhancers may be any of those known in the art and may include, for example, vitamins, minerals, and fiber. When such additions are added to the doughs useful in the present invention, the physical and chemical features of the addition should not interfere with the ability of the dough to form a sheet.

Cracker doughs of the present invention may also optionally comprise enzymes, according to criteria and processes known to those in the art. For instance, proteases, lipases, carbohydrases may optionally be added, to modify the structure, function or flavor of the end product.

The following table provides general guidelines as to the cracker doughs useful in the present invention.

TABLE I
Cracker dough main ingredients

| | Preferred | | |
|---|---|---|---|
| | % by | More Preferred | Most Preferred |
| INGREDIENT | total weight | % by total weight | % by total weight |
| Flour component | 40-80 | 40-70 | 55-65 |
| Fat | 0-15 | 5-10 | 6-8 |
| Moisture | 10-35 | 20-30 | 25-29 |
| Salt | 0-1 | 0.4-1 | 0.6-0.8 |
| Optional ingredients | 0-10 | 0-8 | 0-5 |
| Total | 100.00 | 100.00 | 100.00 |

### Sheeting and Layering Dough

The present invention necessarily involves layering sheets of dough so as to enclose a leavening means within a perimeter of secured dough. The sheets of dough may be formed in any manner, and layered in any manner. The most industrially-efficient means for accomplishing a sheet of dough is to place prepared dough in a hopper that feeds the dough through rollers, or, ideally, a series of roller, so as to reduce the dough from one large mass to a sheet of desired thickness. These techniques are known in the art, and adjusting the thickness of the dough so as to result in the physical attributes desired are also within the skill of the art. Sheeting may be accomplished manually as well, although such a process is ordinarily done a small scale. Large scale dough sheeting may be accomplished via vertical or horizontal sheeting apparati, and may include traditional lamination during the sheeting process, or not. The doughs may be made to have dual or multi-colors or flavors in any given sheet. Layering may also be accomplished via large scale multi-hopper sheeting mechanisms or any other techniques that result in the appropriate configuration as described herein. Multiple layers of dough are within the scope of the present invention.

With regard to the thickness of the sheets, it is optimal to provide a first sheet thickness for the bottom sheet, and a second, greater sheet thickness for the top sheet, so that, after puffing, the sheets are approximately equal thicknesses. The second sheet stretches during puffing, and, since the bottom sheet is bound by the baking surface, the bottom sheet does not stretch to such an extent. The second sheet therefore creates a dome shape. However, if differing dimensions are desired, the relative dough thicknesses may be altered to take the dough stretching phenomenon into account.

The present invention preferably comprises sheets that are 2 millimeters or less in thickness, more preferably 0.75 to 1.5 millimeters, most preferably approximately 1 millimeter thick.

The present invention also preferably comprises laminated dough sheets, more preferably between three and twelve laminations, most preferably between five and nine laminations.

### Leavening Means

The leavening means of the present invention may be any known in the art, and includes microbial, physical and chemical means.

Microbial leavening means include fermenting microorganisms, such as yeasts or bacteria, in conjunction with a food source for such microorganisms, such as sugars. Since the present invention relies on purposeful creation of large cavities, such microorganisms must create enough gas as to result in a large cavity. In one embodiment, a sugar/yeast slurry is placed between at least two sheets, the margins are secured, and the fermentation is encouraged by providing the appropriate fermentation conditions. In another embodiment, the filling contains probiotic bacteria in a fruit- or cream-flavored culture media that provides not only the leavening means, but also health benefits and a desirable filling texture.

Despite the option of using a microbial system for creating a cavity, chemical leavening agents, such as those that are heat activated, or those that create gas via an acid/base system, or some variation of these, are the most industrially-efficient leavening means for use in the present invention. Heat activated leavening agents, such as ammonium bicarbonate, are the most simple to use, since baking is an ideal crisping means in the present invention.

An acid/base leavening system triggers a release of carbon dioxide upon contact with moisture. The evolution of carbon dioxide essentially follows the stoichiometry of typical acid-base reaction. The amount of basic leavening agent present determines the amount of carbon dioxide evolved, whereas the type of acidic leavening agent affects the speed at which the carbon dioxide is liberated. An excess amount of leavening base can impart a bitter flavor to the baked product while excess leavening acid can make the baked product tart. Water and salt are also products of these reactions, with the water dissipating as steam during baking and salt remaining in the food product. Ideally, the salt and/or moisture that remains in the food imparts a benefit to the end product.

Base leavening components suitable for use in the present invention include, for example, sodium bicarbonate and other bicarbonates and/or carbonates. Acid leavening components suitable for use in the present invention include, for example, sodium or calcium salts or ortho-, pyro-, and complex phosphoric acids in which at least two active hydrogen ions are attached to the molecule. Baking acids include monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), and the like. In a preferred embodiment, the acidic leavening agent includes sodium aluminum phosphate, most preferably SAPP 28. One or more of the leavening agents may optionally be encapsulated, either the leavening base or the leavening acid, or both.

In the most preferred embodiment of the present invention, ammonium bicarbonate is the leavening means used because it completely or almost completely dissipates after heat activation. Dry ice may also be used, and will dissipate completely or almost completely after activation.

The present invention preferably comprises leavening agents that are 0.1 to 15% of the total weight percent of the layered dough prior to activation of the agent, more preferably 0.2 to 8%, most preferably 0.3 to 3%. These amounts are in addition to any leavening agent included as a dough ingredient.

### Applying leavening agent

Leavening means is applied between the dough layers, preferably between two layers, such that, upon gas creation, the doughs separate and create a large, cavity that is substantially free of dough obstructions. The most industrially-efficient method of applying leavening agent is to spray or deposit leavening agent on at least one interior surface of a dough layer. For instance, dry deposition of leavening agent on the top surface of the bottom dough layer may be achieved by sifting or otherwise sieving powder in a relatively regular manner so as to fall on the surface via gravity. However, it is also industrially-efficient to spray, via any liquid medium, a solution or slurry of leavening agent on the bottom surface of the top dough layer, the top surface of the bottom layer, or both. Such liquid can include an oil, a sugar slurry, water, a liquid gelatin matrix, starch slurry and the like. Any combination of long and short acting leavening means may be used, and such agents may be applied in any combination of methods as will contribute to the structure of the end product as herein describe. Spraying is particularly efficient if addition of nutritive enhancers via the spray is desired.

Although the most efficient manner to apply leavening agent is to apply it evenly over a surface, it is also possible to apply leavening agent along one lane of surface, or otherwise direct the leavening agent to a particular place on the surface.

The present invention preferably utilizes approximately 0.2 to 2 grams of leavening agent per square foot, more preferably 0.5 to 1.8 grams per square foot, most preferably 0.4 to 1.6 grams per square foot. The strength of the leavening agent determines the amount, with the essential factors being the ability to push the layers apart without destroying the secured perimeter.

The present invention preferably utilizes a knurled roller dispensing means as the means of applying leavening agent between the layers.

### Securing the Perimeter

The leavening means may be trapped between dough layers (so as to form a unbaked dough piece) using any method, with cutting and/or crimping being most industrially-efficient. With traditional cutting, using a smooth-edged cutting roller, the doughs form a continuous seal, and will puff with the least amount of leavening agent present. However, it is also possible to create an intermittent seal, for instance by using a cutting roller with pegs, so as to form an open pattern around the edges, and still result in a puffed, crisp, cracker-like food product herein. In such an embodiment, the formulation may take into account the loss of gas through the edges.

At this stage, the dough may optionally be dockered so as to form designs or to reduce puffing. The number of docker holes and configuration are determined based on the desired end product.

Before baking, preferably 60 to 100% of the perimeter of each unbaked dough piece is secured, more preferably 70-100%, most preferably 90 to 100%. After baking preferably 40 to 100% of the perimeter of each baked food piece is secured prior to packaging, more preferably, 70-95%, most preferably greater than 90%.

### Causing a Cavity to Form

A cavity may be formed by activating the leavening means, preferably in the most industrially-efficient manner. Ideally, the cavities are of an approximately consistent height, and shape, and are not randomly spaced. Cavity formation can occur before or during baking. Cavity formation via baking heat-activated leavening agents is the most efficient, although creating environmental conditions for microorganisms to generate gas is also acceptable. A preferred method is one wherein at least one cavity is formed as part of an in-line process, and necessarily after sheeting, layering and securing the dough with leavening means between layers. Baking at high temperature is preferred, particularly in a band oven, and particularly at temperatures ranging from 400° F. to 750° F., more preferably 450 to 550° F., most preferably approximately 500° F.

Those in the art are aware that different doughs and leavening agents will optimize at different temperatures. The bake temperature also influences bake time, with lower temperatures requiring longer bake times. Bake times in the range of 2 to 15 minutes are preferred, with bake times less than 10 minutes more preferred, and bake times less than 8 minutes most preferred.

In one particular embodiment herein, a buttery-flavored cracker dough is baked at 400 to 450° F. for less than ten minutes, preferably two to eight minutes. In another embodiment, a whole grain dough is baked at similar temperatures and times.

Additionally, several cavities may be formed within one finished food piece by securing but not separating a portion of the dough at a place other than the perimeter. Such cavities are ideally suited for filling, but may also be used to pattern, decorate or otherwise improve the cracker. Moreover, also provided are food products with one contact point in the middle of a puffed cracker, to create a buttoned pillow appearance. In these embodiments, the characteristic of a predictable location and sturdiness are important features.

The present invention provides puffed, crisp, cracker-like products with 70 to 100% of the post-activation pieces having a cavity, more preferably 90 to 100%, most preferably greater than approximately 95%.

### Food Product

The food products of the present invention may be any shape that can be cut and secured, and can have any design features that do not interfere with the underlying functional attributes. A preferred shape of the present invention is a bite-sized rectangle having crimped edges, having approximate dimensions of 1.25 inches by 0.7 inches in length and 0.6 inches in height. However, the food products of the present invention may be animal-shaped, character-shaped, star shaped, etc. Preferred are those shapes which can be tessellated, or those which result in little or no dough waste.

The food products of the present invention has a cavity that is 20 to 60% of the total volume, more preferably 30 to 50%, and most preferably 40 to 45%.

The food products of the present invention have a surprisingly high rate of uncrushed crackers. After shipping, preferably greater than 70% of the baked food pieces are intact, more preferably, greater than 80%, most preferably 90%.

The food products of the present invention have a surprisingly high rate of reproducibility from batch to batch, and among types. After activation of the leavening means, preferably less than 20% of the food pieces fail to puff so as to form at least one cavity substantially free from dough obstructions, more preferably, less than 10%, most preferably 5%.

The present food products may be used to feed humans and other animals, although human food and companion animal food are preferred embodiments.

The puffed, crisp, cracker-like food products are preferably baked to a moisture content of less than 5%, more preferably 2 to 4% moisture, most preferably, approximately 2.5% moisture. When the ingredient percentages are expressed post-baking, the present finished products ideally have the parameters as described in Table II.

TABLE II
Baked Food Product Composition

| | Preferred | | |
|---|---|---|---|
| | % by | More Preferred | Most Preferred |
| INGREDIENT | total weight | % by total weight | % by total weight |
| Flour component | 40-80 | 60-75 | 65-70 |
| Fat | 0-30 | 10-30 | 20-25 |
| Moisture | 0-10 | 1-6 | 1-3 |
| Salt | 0-7 | 1-5 | 1-3 |
| Optional ingredients | 0-20 | 0-10 | 0-5 |
| Total | 100.00 | 100.00 | 100.00 |

In addition, decorative and/or flavor features on the exterior of the food products, such as stripes or designs, are within the scope of the present invention. In particular, external application of oil, water and/or seasoning, particularly salt, as a topping is a preferred embodiment of the present invention.

### Optional Fillings

The present invention may filled with any filling prior to or after activation of the leavening agent. Any such fillings preferably are low-moisture, including powders, low water activity fruit fillings, gum-based fillings, fiber-based fillings, oil-based fillings, or gelatin-based fillings. When applied prior to baking, such fillings may either contain the leavening means, or the leavening means may be applied as a layer to the filling. The filling must allow for activation and puffing of the dough, and must not interfere with securing the perimeter of the unbaked dough piece. The fillings may be sweet or savory, or some combination thereof. When applied after baking, the fillings may be injected or otherwise directed into the puffed cracker so as to limit breakage.

Sweet fillings would be those wherein the primary ingredients are sugars, or ingredients containing sugars, such as fruit, and could additionally contain sugar-complementing herbs and/or spices, such as mint, cinnamon or nutmeg. Savory fillings would be wherein the primary ingredients are meat, cheese, fish or other “umami” ingredients and would include those wherein herbs or spices contribute significantly to the flavor profile, such as garlic or pepper. Combination-type fillings would be those wherein the sugar ingredients and the savory ingredients mingle, such as fruit curries or mincemeat.

### Optional Toppings

A preferred embodiment of the present invention is a puffed, crisp, cracker-like food product with an application of oil on at least one exterior surface after baking. Oil may be applied in any method known in the art and includes spraying, dipping, application by an oil-soaked medium, such as a sponge, or any other application method. This application of oil is absorbed and provides additional flavor complexity. Additional toppings, such as seasoning, preferably salt, and coatings, such as a sugar slurry, are also included. Enrobing with chocolate, or other flavored coatings is also within the scope of the present invention, as is printed material using food dye.

### EXAMPLE 1

### The Embodiment Shown in the Figures

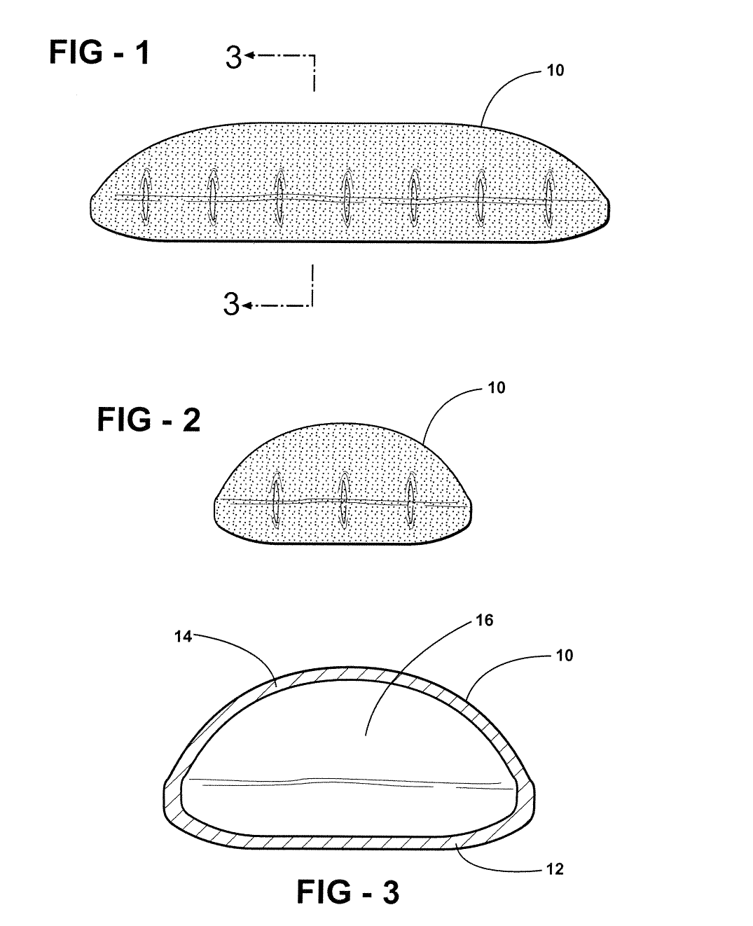

In a particular embodiment, the present invention is directed to a puffed, crisp, cracker-like food product 10 as illustrated in FIGS. 1-3. The puffed shape is formed from a large cavity 16. The cracker 10 generally includes a first layer 12 that forms a lower portion and a second layer 14 which forms an upper portion. The second layer 14 is joined to the first layer 12 at or approximate to a perimeter edge 19.

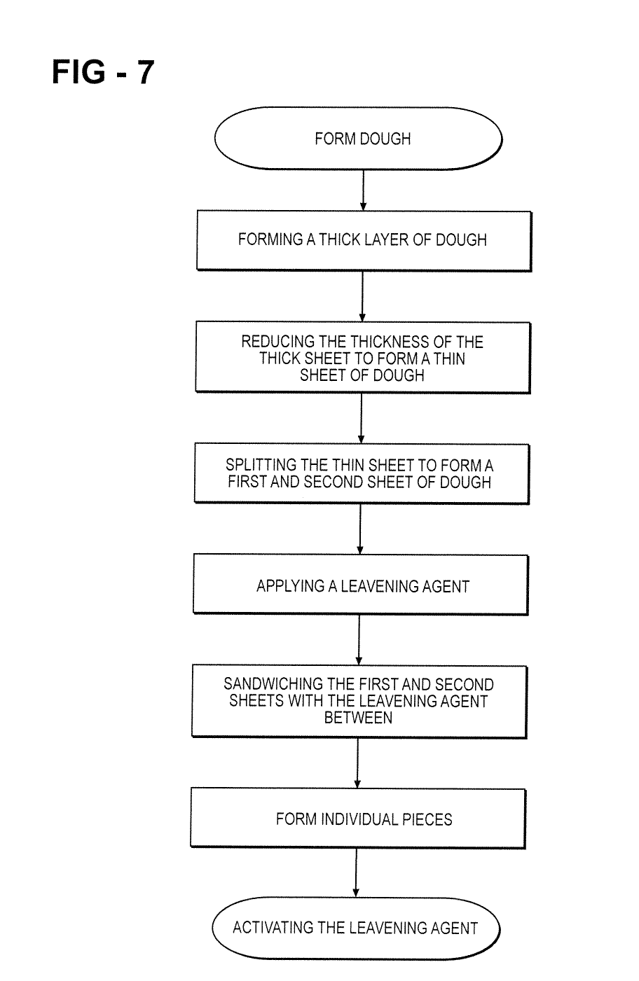

An industrial process for forming the product 10 described above is generally illustrated in FIG. 7. The dough is first prepared, and bulk dough pieces are rolled or pressed into a thick layer of dough. Dough pieces are regularly fed to the hopper to assure a continuous process. This dough is then reduced in thickness, laminated, and formed by rollers into a sheet of dough that is less than 2 mm in thickness. In the exemplary embodiment, the dough is laminated between three and twelve laminations.

The sheet is divided such that a first sheet of dough continues along a flat conveyor while the second sheet of dough is elevated up on to a second conveyor and then shifted over to overlie the first sheet of dough with an elevation between.

With the sheets divided, ammonium bicarbonate is applied to the first sheet 12 of dough. Approximately 0.2 to 2 grams of ammonium bicarbonate is applied per square foot of dough to provide sufficient puffing of the cracker to create the desired cavity.

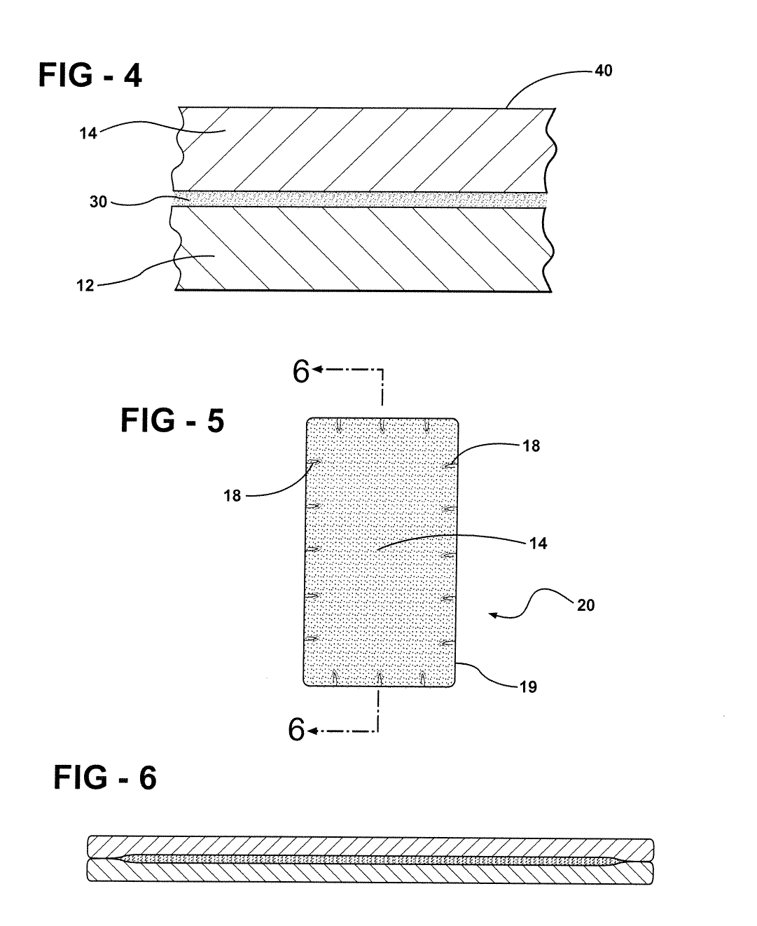

FIG. 4 shows the first sheet of dough 12 with the second sheet of dough 14 and the leavening agent 30 applied between the first and second sheets of dough 12 and 14 to form the continuous sheet 40.

The continuous sheet of dough 40 is then cut into individual unbaked cracker pieces 20 as illustrated in FIG. 5. In this exemplary embodiment, a rotary cutter is used that both crimps and cuts the dough. Other cutting methods that may be used include transversal knife, rotary disc, or guillotine cutters.

Individual dough pieces are then transferred to an oven belt, and passed into an oven. In the exemplary embodiment, the dough pieces are baked for approximately 2.5 minutes at a temperature of about 450 to 550° F. During the baking process, the leavening agent 30 becomes activated, causing the cracker to puff and form an individual cavity 16. The ammonium bicarbonate decomposes to form a carbon dioxide, ammonia and water, thereby causing the top dough to expand, and the ammonium bicarbonate to dissipate into the environment. The puffed, crisp cracker-like food product is cooled, oiled, topped with salt, and packaged.

### EXAMPLE 2

### Preparation of a Dill and Rye-Flavored Puffed, Crisp Food Product

| Cracker Dough Ingredients | Measurement |
|---|---|
| unbleached white flour | 2 cups |
| whole wheat flour | .5 cup |
| rye flour | .5 cup |
| salt | 1 teaspoon |
| unsalted butter, softened | .5 cup |
| warm water | .5 cup |
| finely snipped dill leaves | 3 tablespoons |
| salt | 1 teaspoon |
| dill seed | 1 teaspoon |

The flours and one teaspoon salt are mixed in a large bowl. The softened butter is processed in a food processor with the flour and salt mixture to make a fine meal. The warm water and dill leaves are mixed into the flour, salt and butter mixture. The dough is kneaded for five minutes.

A half-cup portion of dough is rolled very thin between two sheets of waxed paper, preferably to a create a sheet that is approximately 2 millimeters thick. Another half-cup portion is rolled between two sheets of waxed paper to create a similarly thin sheet of dough. The waxed paper is removed from the top surface of the first sheet of dough. Approximately seven teaspoons of ammonium bicarbonate are sprinkled over the top surface of the first sheet of dough, so as to evenly cover the surface. The second sheet of dough is placed over the ammonium bicarbonate layer. The waxed paper is removed from the top surface of the second piece of dough. Using a pizza cutter, the first and second layer are secured in 1 inch by 0.75 inch rectangular portions by making two cuts perpendicular to each other. The pieces are then transferred from the waxed paper surface to a cookie sheet. The pieces are crimped around the edges with a fork, thereby creating a 1-2 mm margin around the edges. The squares are baked at 450° F. for approximately eight minutes, so as to brown and puff the cracker layers.

### EXAMPLE 3

### Preparation of a Graham Cracker-Flavored Puffed, Crisp Food Product

| Cracker Dough Ingredients | Measurement |
|---|---|
| oil | ¼ cup |
| honey | ⅓ cup |
| molasses | 2 tablespoons |
| vanilla | 1 teaspoon |
| whole wheat flour | 2½ cup |
| baking powder | 1 teaspoon |
| salt | ¼ teaspoon |
| cinnamon | 1 teaspoon |
| milk | ¼ to ½ cup |

Oil, honey, molasses and vanilla are mixed in a first bowl. Flour, baking powder, salt and cinnamon are combined in a second bowl. The dry mix is added to the liquids, alternating with milk. The combination is mixed well.

A half-cup portion of dough is rolled very thin between two sheets of waxed paper, preferably to a create a sheet that is approximately 2 millimeters thick. Another half-cup portion is rolled between two sheets of waxed paper to create a similarly thin sheet of dough. The waxed paper is removed from the top surface of the first sheet of dough. Approximately eight teaspoons of ammonium bicarbonate and two teaspoons of cinnamon are sprinkled over the top surface of the first sheet of dough, so as to cover the surface. The second sheet of dough is placed over the ammonium bicarbonate and layered with the second dough. The waxed paper is removed from the top surface of the second piece of dough. Using cookie cutters of various shapes, pieces are cut from the layered sheets. The pieces are then transferred from the waxed paper surface to a cookie sheet. The pieces are then crimped around the edges with a fork, creating a 2-3 mm margin around the edges. The squares are baked at 500° F. for six to ten minutes, so as to brown and puff the cracker layers. The puffed crackers are brushed with canola oil so as to create a thin film, and sprinkled with one teaspoon granulated sugar per cracker.

### EXAMPLE 3

### Preparation of a buttery-Flavored Puffed, Crisp Food Product

| Cracker Dough Ingredients | Measurement |
|---|---|
| flour | 3 cup |
| unsalted butter | ¾ cup |
| sugar | 3 tablespoons |
| salt | 1½ teaspoons |
| milk | 1 cup |

The first flour ingredients are crumbled together. The milk is then added and stirred to make a stiff dough. A half-cup portion of dough is rolled very thin between two sheets of waxed paper, preferably to a create a sheet that is approximately 2 millimeters thick. Approximately 4 teaspoons of ammonium bicarbonate is sprinkled over the top surface of the sheet of dough, so as to cover the surface. The dough is then folded on itself and the waxed paper removed from the top surface. Using a pastry wheel, one inch strips are cut. The pastry wheel is then used to cut diagonally across the strips, so as to create wavy-edged rectangles having a 1 inch short edge. The pieces are then transferred from the waxed paper surface to a cookie sheet. The squares are baked at 500° F. for four to six minutes, so as to brown and puff the cracker layers.

### EXAMPLE 4

### Preparation of Bacon and Cheese Puffed, Crisp Food Product

| Cracker Dough Ingredients | Measurement |
|---|---|
| all-purpose flour | 1½ cup |
| cheddar cheese, shredded | ½ cup |
| parmesan cheese, grated | 2 tablespoons |
| baking soda | ½ teaspoon |
| salt | ¼ teaspoon |
| black pepper, ground | ⅛ teaspoon |
| sour cream | ½ cup |
| bacon drippings | 3 tablespoons |

The flour, cheeses, baking soda, salt and pepper are combined in a bowl. The sour cream and bacon drippings are stirred into the combination. A half-cup portion of dough is rolled very thin between two sheets of waxed paper, preferably to a create a sheet that is approximately 2 millimeters thick. Three and one half teaspoons of ammonium bicarbonate, and two teaspoons cooked and crumbled bacon pieces are sprinkled over the top surface of the sheet of dough, so as to cover the surface. The dough is then folded on itself and the waxed paper removed from the top surface. Using a knife, 1.5 inch squares are cut. The pieces are then transferred from the waxed paper surface to a cookie sheet. A fork is used to crimp an approximately 1 mm perimeter. The squares are baked at 500° F. for four to six minutes, so as to brown and puff the cracker layers.

The puffed cracker-like products are then sprayed with canola oil and topped with grated parmesan cheese.

What is claimed is:

1. A puffed, crisp, cracker-like food product comprising: at least two layers of baked dough having at least one cavity, wherein said cavity is substantially defined by a secured dough perimeter, wherein said cavity is substantially free of baked dough obstructions.

2. A food product of claim 1, wherein said cavity is 20 to 70% of the total volume of the food product.

3. A food product of claim 1, wherein said layers comprise a bottom layer and a top layer, said layers having approximately the same thickness.

4. A food product of claim 1, which comprises one to three cavities.

5. A food product of claim 3, which comprises one cavity.

6. A food product of claim 1, wherein said dough is a flavored cracker dough.

7. A food product of claim 6, wherein said dough flavor is selected from the group consisting of: buttery flavor; multi-grain flavor; cheddar flavor; chocolate flavor; wheat flavor; cinnamon flavor; onion flavor; fish flavor; pretzel flavor; garlic flavor; parmesan flavor; graham flavor; sesame flavor; corn flavor; legume flavor; beef flavor; chicken flavor; lamb flavor; shrimp flavor; nacho seasoning flavor; potato flavor; green chile flavor; ranch salad dressing flavor; tomato flavor; apple flavor; mint flavor; rosemary flavor; mixed fruit flavor; mixed vegetable flavor; mixed meat flavor; mixed spice flavor; and mixed herb flavor.

8. A food product of claim 1, which further comprises a seasoning on at least one surface.

9. A food product of claim 1, which further comprises a filling.

10. A food product of claim 9, wherein said filling base is selected from the group consisting of: oil base filling; gum base filling; powdered filling; fruit base filling; gelatin base filling.

11. A food product of claim 9, wherein the filling is a flavor selected from the group consisting of: vanilla flavor; strawberry flavor; raspberry flavor; caramel flavor; squash flavor; butter flavor; cheddar flavor; blue cheese flavor, nacho cheese flavor; chocolate flavor; cinnamon flavor; onion flavor; fish flavor; pretzel flavor; garlic flavor; parmesan flavor; malt flavor; sesame flavor; legume flavor; beef flavor; chicken flavor; lamb flavor; shrimp flavor; potato flavor; green chile flavor; tomato flavor; apple flavor; peach flavor; banana flavor; cranberry flavor; pomegranate flavor; green tea flavor; grape flavor; raisin flavor; liqueur flavor; liquor flavor; wine flavor; beer flavor; mint flavor; rosemary flavor; basil flavor; cilantro flavor; chive flavor; mixed fruit flavor; mixed vegetable flavor; mixed meat flavor; mixed spice flavor; and mixed herb flavor.

12. A food product of claim 1, comprising at least two different doughs as the layers.

13. A food product of claim 1, comprising at least one sweetened dough.

14. A food product of claim 1, wherein said dough comprises at least one whole grain ingredient.

15. A food product of claim 1, wherein said food product comprises at least one nutritive enhancer.

16. A food product of claim 13, wherein said nutritive enhancer is selected from the group consisting of: soluble fiber; insoluble fiber; fructo-oligosaccharides; inulins; psyllium husk fiber; citrus fiber; oat fiber; microground fiber; vegetable gums; dextrins; resistant starches; grain brans; oat brans; wheat brans; corn brans; cactus extracts; beta carotene; quinoa; whey protein extracts; omega fatty acids; spirulinas; brown seaweeds; probiotics; prebiotics; ginko bilboa; flax seed; flax seed oil; saw palmetto; grape seed extract; milk thistle; bilberry; green tea; Echinacea; cohosh; cayenne; saponins; antioxidants; ginsing; wild yam extract; yohimbe; noni; algae; fruit vinegar; fruit concentrate; mangosteen; acai; goji; pomegranate; wheat grass; chlorella; sterols; wheat grass; alfalfa; barley grass; phytonutrients; beet fiber; oat fiber; apple pectin; black current fiber; flavones; isoflavones; soy; evening primrose oil; essential fatty acids; eicosapentanoid acid; docosahaenoic acid; bee pollen; royal jelly; creatine; caffeine; zinc; vitamins; minerals; aloe; Hoodia; conjugated linoleic acid; Caralluma fibriata; and olive oil.

17. A method to make a puffed, crisp food product, comprising:
providing leavening means between at least two sheets of dough;
securing said dough sheets so as to define a perimeter;
causing at least one cavity to form within said perimeter, wherein said cavity is substantially free of baked dough obstructions.

18. A method of claim 17, wherein said leavening means is selected from the group consisting of: fermenting a fermenting microorganism; reacting an acid with a base; heating a heat-activated leavening agent.

19. A method of claim 17, wherein said leavening means comprises at least one leavening agent selected from the group consisting of: yeasts; probiotic bacteria; ammonium bicarbonate; sodium bicarbonate; calcium bicarbonate; carbonates; sodium salts; calcium salts; ortho phosphoric acids; pyro phosphoric acid; complex phosphoric acids; monocalcium phosphate monohydrate; monocalcium phosphate anhydrous; sodium acid pyrophosphate; sodium aluminum phosphate; dicalcium phosphate dehydrate; dicalcium phosphate; sodium aluminum sulfate; glucono-deltalactone; potassium hydrogen tartrate; sodium aluminum phosphate.

20. A method of claim 17, wherein said leavening means is ammonium bicarbonate.

21. A method of claim 20, wherein said cavity is caused by subjecting said dough layers and ammonium bicarbonate to heat sufficient to cause said dough layers to separate, said ammonium bicarbonate to dissipate, and said perimeter to remain substantially secured.

22. A method of claim 17, wherein said dough sheets are secured by cutting the dough sheets after layering.

23. A method to make a puffed, crisp food product, comprising:
providing a first sheet of dough;
providing a layer of ammonium bicarbonate to the top surface of the first sheet of dough;
providing a second sheet of dough to the surface of the ammonium bicarbonate;
cutting said doughs and ammonium bicarbonate layer so as to secure a perimeter of dough; and
baking so as to activate the ammonium bicarbonate and crisp the dough.

24. The process of claim 23, wherein said dough is less than two millimeters in thickness prior to baking.
